(19) United States
(12) Patent Application Publication
(10) Pub. No.: US 2026/0113516 A1
(43) Pub. Date: Apr. 23, 2026

(54) REALTIME MEDIA PROVENANCE VERIFICATION SYSTEM

(71) Applicant: T-ZERO SECURITY, INC., LAKE OSWEGO, OR (US)

(72) Inventors: Joshua McKenty, Victoria (CA); Khadem Badiyan, Lake Oswego, OR (US)

(73) Assignee: COSENTIO, INC., Seattle, WA (US)

(21) Appl. No.: 19/118,896

(22) PCT Filed: Oct. 14, 2024
(86) PCT No.: PCT/US2024/051274

§ 371 Date: Apr. 7, 2025

Related U.S. Application Data
(60) Provisional application No. 63/589,969, filed on Oct. 12, 2023.

(51) Int. Cl. H04N 21/8358; H04L 9/00; H04L 9/32

(52) U.S. Cl. CPC H04N 21/8358; H04L 9/3247; H04L 9/50

(57) ABSTRACT

Apparatus and associated methods relate to generating and verifying a tamper-proof media (e.g., an image, a video). In an illustrative example, a media provenance verification system (MPVS) may automatically verify a provenance of a media file of temporally related frames. The MPVS, for example, may retrieve verification records associated with the media file from a decentralized ledger. The MPVS may select a verification record corresponding to a media frame of the media file. From the media frame, the MPVS may extract a laser security signature of the media frame. For example, the laser security signature may include a clock pattern related to a public verifiable random value (PVR), a depth marker, and a hash of a previous media frame. In some implementations, the media frame may be determined to be real when a time provenance related to a creation time, a depth provenance related to an image depth, and a continuity provenance related to a continuity are passed. Various embodiments may advantageously provide a real-time tamper-proof video validation.

### CROSS-REFERENCE TO RELATED APPLICATIONS

This application claims the benefit of U.S. Provisional Application Ser. No. 63/589,969, titled “REALTIME MEDIA PROVENANCE VERIFICATION SYSTEM,” filed by Joshua Mckenty, et al., on Oct. 12, 2023.

This application incorporates the entire contents of the foregoing application(s) herein by reference.

### TECHNICAL FIELD

Various embodiments relate generally to systems and methods related to provenance of media content.

### BACKGROUND

The ubiquity of manipulated media has a corrosive effect on public trust. Technologies, for example, have made modifying videos available in a variety of ways, ranging from basic edits like cropping and splicing to more sophisticated techniques such as color correction, audio dubbing, and/or motion tracking. With the use of digital tools, for example, even subtle changes to facial expressions and/or the synchronization of speech with lip movements may be applied to drastically alter the perception of a video's content. Bad actors may, in some cases, may use these modification techniques to mislead viewers or spread misinformation.

One of the most concerning developments in media manipulation may be the rise of “deepfakes.” Deepfakes, for example, may include videos created using artificial intelligence (AI) and machine learning technologies to produce hyper-realistic images and audio. Deepfakes may, for example, manipulate a person's likeness, making them appear to say or do things they never actually did. The form of synthetic media may be nearly indistinguishable from authentic footage, posing a significant challenge to identifying manipulated content.

As an illustrative example, a deepfake video of the Ukrainian president telling his soldiers to surrender to Russia may induce a long lasting impact in any trustworthiness of future commands from the president. For example, the video may cause people to question every other video coming from Ukraine. Deepfake videos may sometimes blur the line between fact and fiction and undermine public trust in recorded images and videos as objective depictions of reality. As such, the availability of the deepfake technology may create a climate where even authentic information is met with skepticism, impacting not just individual beliefs but collective decision-making processes at the societal level.

### SUMMARY

Apparatus and associated methods relate to generating and verifying a tamper-proof media (e.g., an image, a video). In an illustrative example, a media provenance verification system (MPVS) may automatically verify a provenance of a media file of temporally related frames. The MPVS, for example, may retrieve verification records associated with the media file from a decentralized ledger. The MPVS may select a verification record corresponding to a media frame of the media file. From the media frame, the MPVS may extract a laser security signature of the media frame. For example, the laser security signature may include a clock pattern related to a public verifiable random value (PVR), a depth marker, and a hash of a previous media frame. In some implementations, the media frame may be determined to be real when a time provenance related to a creation time, a depth provenance related to an image depth, and a continuity provenance related to a continuity are passed. Various embodiments may advantageously provide a real-time tamper-proof video validation.

Apparatus and associated methods relate to generating and verifying a tamper-proof media (e.g., an image, a video). In an illustrative example, a media provenance verification system (MPVS) may automatically generate a tamper-proof media comprising a sequence of media frames by associating a security signature stored in a decentralized ledger and comprising a public verifiable random value, a physical value related to the media frame, and a continuity value. For example, the MPVS may project a laser security signature to be physically captured into the media frame by a media capturing device. For example, the laser security signature may include a PVR, an encoded physical property of a media frame, and a hash of a previous frame. For each media frame, the MPVS generates a verification record including a timestamp and a hash of the frame to be stored in a decentralized ledger. Various embodiments may advantageously generate a sequence of tamper-proof verification records in the decentralized ledger.

Various embodiments may achieve one or more advantages. For example, some embodiments may advantageously be more than a digital signature, but also an irrefutable temporal marker. Some embodiments, for example, may advantageously provide an immutable proof of a time when a media content was created. For example, some embodiments may advantageously validate whether video was captured from a pre-recorded scene displayed on a screen or an actual three-dimensional scene. Some embodiments may advantageously ensure that the media content wasn't fabricated after the fact (e.g., falsely backdated). For example, some embodiments may advantageously validate whether a media content is predated. Some embodiments may advantageously detect deepfake videos by analyzing interactions between different wavelengths of the colors and objects. For example, some embodiments may advantageously ensure a truly random and unbiased selection process. Some embodiments may, for example, advantageously automatically generate a tamper-proof media comprising a sequence of media frames by associating a security signature stored in a decentralized ledger and comprising a public verifiable random value, a physical value related to the media frame, and a continuity value. For example, some embodiments may advantageously validate a media frame to be both authentic and untampered with a multi-layered validation process. Some embodiments may, for example, advantageously allow validation of images with some amount of editing.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary provable media verification system (PMVS) employed in an illustrative use-case scenario.

FIG. 2 is a block diagram depicting an exemplary media provenance real-time verification system (MPRV).

FIG. 3A and FIG. 3B depict an exemplary laser security signature projected onto a scene.

FIG. 4A and FIG. 4B depict exemplary clock laser and depth laser projections configured to represent a depth marker of a captured scene.

FIG. 5A, FIG. 5B, and FIG. 5C depict exemplary value boxes configured to represent various values in a scene.

FIG. 6 is a block diagram depicting an exemplary consensus process in selecting a public verifiable random value.

FIG. 7 is a flowchart illustrating an exemplary provable video generation method.

FIG. 8 is a flowchart illustrating an exemplary provenance media verification record validation method.

FIG. 9 is a flowchart illustrating an exemplary provable video real-time verification method.

FIG. 10 is a flowchart illustrating an exemplary runtime verification method.

Like reference symbols in the various drawings indicate like elements.

### DETAILED DESCRIPTION OF ILLUSTRATIVE EMBODIMENTS

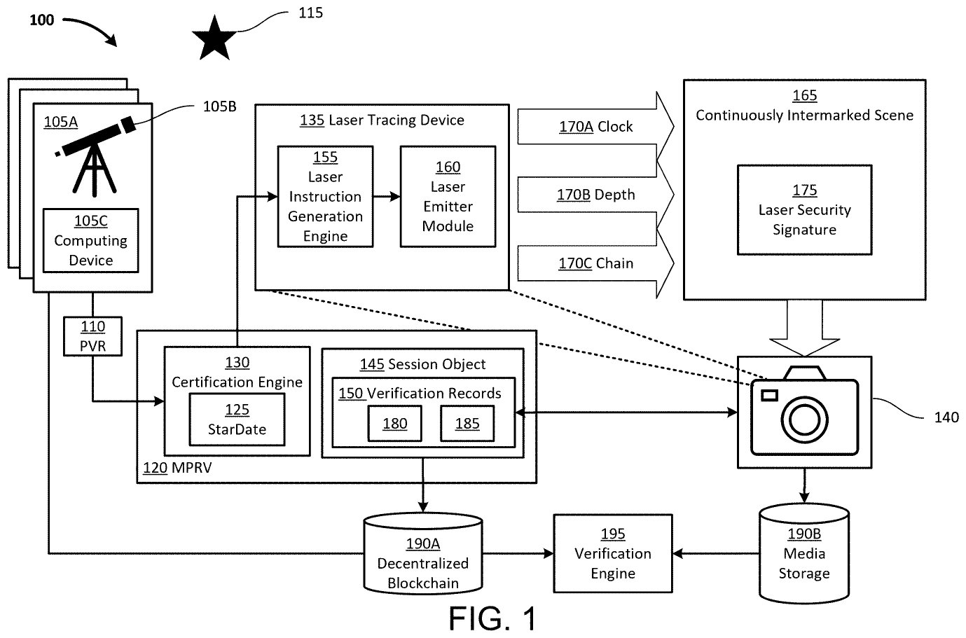

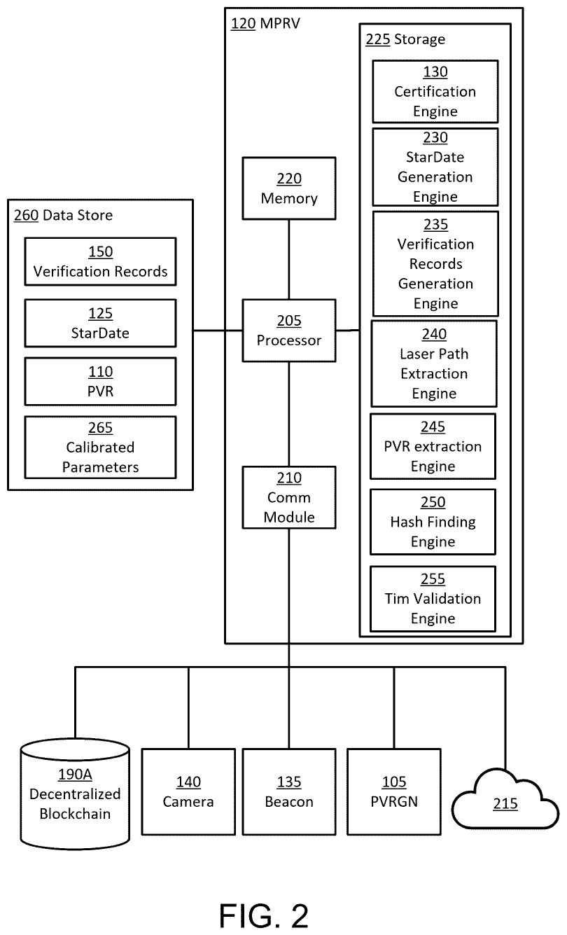

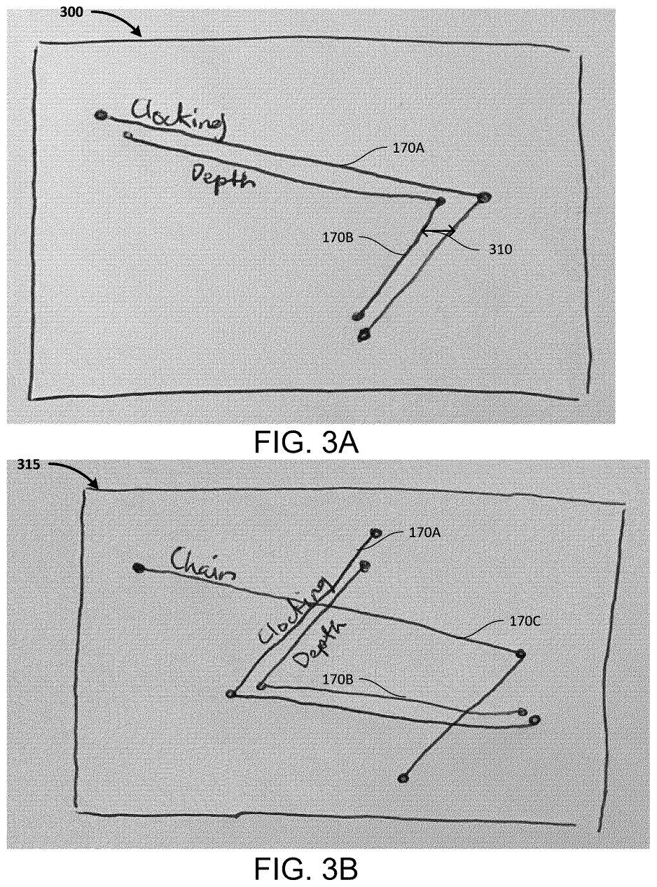

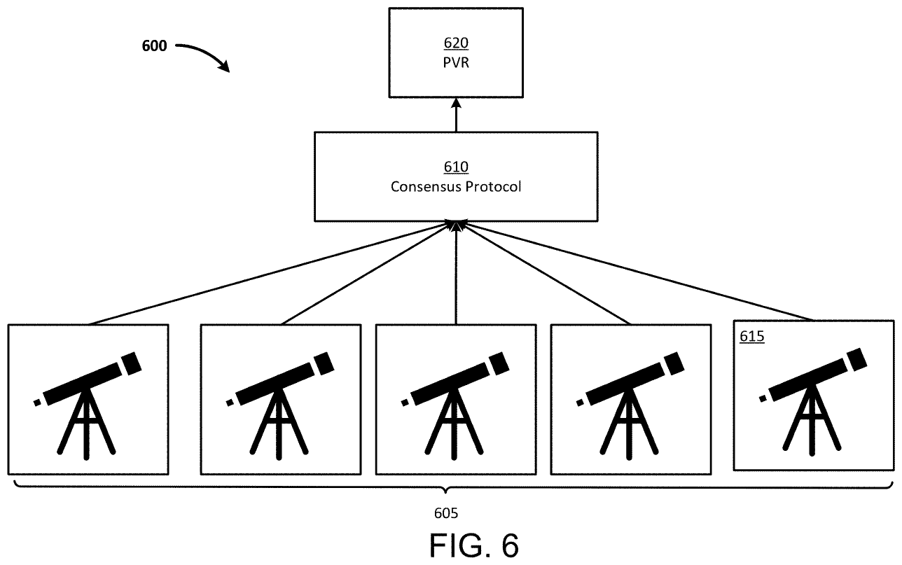

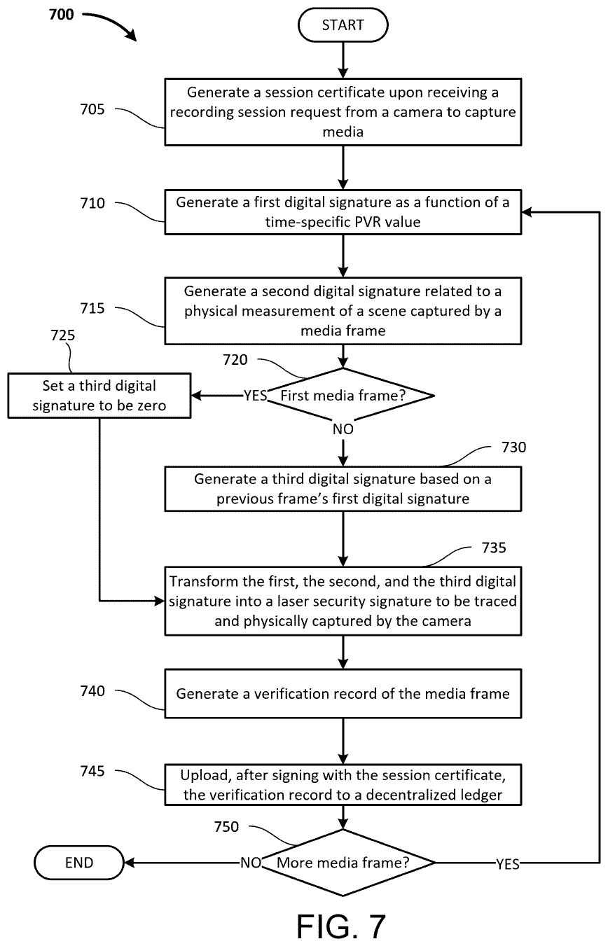

To aid understanding, this document is organized as follows. First, to help introduce discussion of various embodiments, a media provenance verification system (MPVS) is introduced with reference to FIGS. 1-2. Second, that introduction leads into a description with reference to FIGS. 3A-5C of some exemplary embodiments of a laser security signature encoding system. Third, with reference to FIG. 6, a decentralized consensus network is described in application to exemplary generating a public verifiable random value. Fourth, with reference to FIGS. 7-10, this document describes exemplary apparatus and methods useful for generating and verifying tamper-proof media. Finally, the document discusses further embodiments, exemplary applications and aspects relating to MVPS.

FIG. 1 depicts an exemplary provable media verification system (PMVS) employed in an illustrative use-case scenario. In the depicted example, a user may use a PMVS 100 to a provable media. For example, another user may verify the provable media using the PMVS 100.

As shown, the PMVS 100 includes a public verifiable random generation network (PVRGN 105). The PVRGN 105 includes multiple (e.g., 2, 3, 3 or more) nodes 105A. For example, the PVRGN 105 may generate a public verifiable random number (PVR 110) as a function of a near-real-time pulsar timing noise (PTN).

For example, each of nodes 105A may receive regular beams of radio waves (pulses) from a pulsar 115. For example, the pulses may be very steady and be observed as precise cosmic clocks. In some examples, there are deviations and irregularities in these steady pulse sequences. For example, the PTN may be a measurement of these deviations and irregularities. One property of the PTN may, for example, be its unpredictability. For example, the PTN may be independently detected by a radio telescope 105B of each of the nodes 105A.

As shown, each of the nodes 105A includes a computing device 105C. In some implementations, using the radio telescope 105B and the computing device 105C, the nodes 105A may have various properties of the PTN. For example, the nodes 105A may measure specific frequencies of the PTN. For example, the nodes 105A may measure an overall noise. For example, the nodes 105A may measure specific frequencies of a pulsar flux density (PFD). For example, the nodes 105A may measure an overall PFD.

All nodes 105A may, in some embodiments, be set to observe the same pulsar (e.g., the pulsar 115) as each other. In some implementations, the PVRGN 105 may include a mechanism to change an observation target for the nodes 105A throughout the day. For example, the PVRGN 105 may each be an independent observer.

In some implementations, the nodes 105A may measure the same PTN from the radio telescope 105B in different locations (e.g., each radio telescope 105B may be up to 1000 miles away). For example, the radio telescope 105B of the PVRGN 105 may be measuring the same pulsar (e.g., the PVR 110).

In some implementations, the radio telescope 105B may be assigned to measure different pulsars. For example, the radio telescope 105B may be activated to focus on one of multiple pulsars based on a location of the specific radio telescope 105B relative to the pulsar. For example, the PVRGN 105 may measure 4 pulsars simultaneously and continuously. In some implementations, the PVRGN 105 may control the radio telescope 105B to shift focus on which one of the four pulsars based on their location relative to the pulsars.

In some implementations, each computing device 105C may apply a method of pulsar frequency slicing (e.g., by dividing a signal into frequency bands) to extract more bits of data. For example, some embodiments may avoid using a traditional de-dispersal process. Various embodiments may enhance the amount and precision of data extracted from pulsar signals.

In some implementations, the PVRGN 105 may include a consensus protocol to generate the PVR 110. For example, the PVRGN 105 may include a reliable, replicated, redundant, and fault-tolerant (RAFT) consensus protocol. For example, once observations have been made by the nodes 105A, using the RAFT consensus protocol, the PVRGN 105 may select a leader node amongst the nodes 105A based on time zone. For example, the nodes 105A may send their observations to the leader node. For example, these observations may be put into a queue. For example, the leader node may submit that value to an output interface (e.g., an application program interface (API) installed in the computing device 105C when there is enough (⅗) confirmations of a PTN observation.

The computing device 105C may generate the PVR 110 based on the API and the PTN observation. In some implementations, the PVR 110 may be generated based on a globally observable event. For example, the PVR 110 may be tamper-proof by distance. Accordingly, for example, the PVR 110 may advantageously be non-terrestrial. For example, the PTN may be globally accessible (e.g., available to be measured in different nations, between multiple counterparties).

For example, the PTN may be received with a significant time delay (e.g., generated 5,000 years or more at the pulsar 115). For example, the PTN may be generated with a broad frequency spectrum. For example, the PVRGN 105 may generate the PVR 110 continuously when the pulsar 115 is in-view with the nodes 105A. For example, the PVRGN 105 may generate the PVR 110 as a function of the PTN. For example, the PVR 110 may be used to generate a monotonically increasing time basis value (e.g., a StarDate 125). For example, the StarDate 125 may be used as a timekeeping metric that may continuously increase as more of the PVR 110 is gathered.

As shown, the PMVS 100 includes media provenance real-time verifier (MPRV 120). The MPRV 120 includes a certification engine 130 coupled to the PVRGN 105. For example, the certification engine 130 may be connected to the PVRGN 105 through a communication network. In some implementations, the certification engine 130 may publish a log of the PVR 110 received from the PVRGN 105 and all derived StarDates. In some implementations, the StarDate 125 may be represented as a mission standard date (MSD) independent of cultures and time zones.

The PMVS 100 includes a laser tracing device 135 in this example. The laser tracing device 135 may be remotely connected to the certification engine 130. In some examples, a user may use the laser tracing device 135 and a camera 140 to generate tamper-proof videos.

As an illustrative example without limitations, at a beginning of a video capturing session, the camera 140 may fetch a session certificate from the certification engine 130. When issuing this certificate, the certification engine 130 may generate a session object 145 associated with the session certificate. As shown, the session object 145 includes verification records 150 generated during the video capturing session. For example, the MPRV 120 may populate the session object 145 during a recording session of the camera 140. For example, the recording session may include a media stream with a temporally sequence of media frames.

The laser tracing device 135 includes a laser instruction generation engine 155 and a laser emitter module 160. For example, the laser tracing device 135 may project an intermarking signature onto a continuously intermarked scene (CIS 165) to be captured by the camera 140. For example, the CIS 165 may include a scene in front of the camera to be captured. For example, the CIS 165 may be included in a media frame of the recording session.

In this example, the laser emitter module 160 may include three colored lasers. For example, the laser emitter module 160 may be controlled by instructions generated by the laser instruction generation engine 155.

As shown, the three colored lasers include a clock laser 170A, a depth laser 170B, and a chain laser 170C). For example, the clock laser 170A may receive the StarDate 125 from the certification engine 130. For example, the laser instruction generation engine 155 may generate an instruction to the laser emitter module 160 based on the StarDate 125. For example, the clock laser 170A may draw loops on the CIS 165 to encode the StarDate 125 onto the CIS 165. For example, the depth laser 170B may draw a loop near the clock laser 170A to capture a depth of the CIS 165 to be captured by the camera 140. For example, the MPRV may derive an image depth by applying parallax on the clock laser 170A and the depth laser 170B. For example, the chain laser 170C may draw a loop to encode a hash (e.g., a MD5 hash) of a previous frame to manifest a continuity between sequential frames containing the CIS 165. In various embodiments, the laser tracing device 135 may project a laser security signature 175 including space, time, and continuity information onto the CIS 165 to be captured by the camera 140. Various encoding mechanisms and/or applications are described further with reference to FIGS. 3A-5C.

In some embodiments, the laser instruction generation engine 155 may generate the clock laser 170A to trace a newly received PVR. For example, if no new PVR is received, the laser instruction generation engine 155 may instruct the laser emitter module 160 to generate a previous frame's hash as the clock laser 170A.

In some implementations, the laser instruction generation engine 155 may instruct the depth laser 170B to follow the clock laser 170A with a predetermined (e.g., calibrated) offset of the clock laser 170A. In some examples, the predetermined offset may be retrievable from the session object 145 to gauge an image depth as the clock laser 170A and the depth laser 170B move through the CIS 165. For example, the image depth may advantageously be used in measuring inconsistencies in depth to advantageously detect tampered videos.

In some implementations, the chain laser 170C may follow an exact same path as the clock laser 170A in a previous frame. For example, analyzing the chain laser 170C may determine continuity of a captured media In some implementations, the laser tracing device 135 may be a light-based device (releasably) attachable to the camera 140 or a mobile device (e.g., a smart phone). For example, the laser tracing device 135 may be embedded within a phone case. For example, the camera 140 may be connected to the MPRV 120 wirelessly. For example, the laser tracing device 135 may be connected to the MPRV 120 through the camera 140. In some implementations, the laser instruction generation engine 155 may continuously update the laser security signature 175 as a function of the PVR 110. For example, the laser security signature 175 may be unique and traceable.

In some implementations, for each predetermined number of frames (e.g., every frame, every tenth frame, every twentieth frame, every fifth frame) of the video, the laser instruction generation engine 155 may generate a cryptographic hash 180 by applying a ray tracing light to a scene of the frame. For example, the ray tracing light may be generated by depth sensors (e.g., using an auto-focus module on the camera 140 or a smartphone. For example, the laser instruction generation engine 155 may generate the cryptographic hash 180 based on the depth measurement. In some implementations, the camera 140 may upload the verification records 150 including the cryptographic hash 180 and a timestamp 185 to the MPRV 120. For example, the timestamp 185 may be generated based on the StarDate 125. For example, the MPRV 120 may include the received verification records 150 into the session object 145 associated with the current media session. In some implementations, the verification records 150 may be signed by the session key. For example, the verification records 150 may be registered with a current recording session.

In some implementations, the MPRV 120 may store the session object 145 in a decentralized blockchain 190A. For example, the camera 140 may store a video generated from the media session to a media storage 190B. For example, the media storage 190B may be a public storage. For example, the media storage 190B may be a private secured storage.

In various implementations, the laser security signature 175 generated based on the PVR 110 may project a seal of authenticity on each image or video. The laser security signature 175 may also include a real-time cryptographic access code for the image or video. In this example, a user may verify a video in the media storage 190B using a verification engine 195. For example, the verification engine 195 may apply a proof of real verification to the video based on the laser security signature 175 captured in frames of the video and the verification records 150. In some implementations, the verification engine 195 may include a validation application programming interface (API) to verify an authenticity of a frame captured using the PMVS 100.

For example, the cryptographic hash 180 may include properties of the CIS 165 (e.g., an image depth in various areas in the CIS 165). Accordingly, for example, the cryptographic hash 180 may advantageously be more than a digital signature, but also an irrefutable temporal marker related to the CIS 165. For example, the cryptographic hash 180 may be stored on the decentralized blockchain 190A associated with the timestamp 185. Accordingly, for example, the verification records 150 may advantageously provide an immutable proof of a time when a media content was created. In some examples, because the cryptographic hash 180 include physical properties (e.g., a depth measurement) of the CIS 165, the decentralized blockchain 190A may advantageously validate whether the camera 140 is capturing a pre-recorded scene displayed on a screen or an actual three-dimensional scene.

In some implementations, the timestamp 185 may be hashed to securely provide an immutable evidence of a related media's creation time. For example, the verification engine 195 may advantageously use the verification records 150 to ensure that the media content wasn't fabricated after the fact (e.g., falsely backdated).

For example, a timestamp extracted from a media frame displaying the CIS 165 may be extracted from the clock laser 170A. In some implementations, the laser instruction generation engine 155 may generate the clock laser 170A based on the PVR 110. For example, because the PVR 110 is not predictable before observation, the verification engine 195 may advantageously validate whether a media content is predated. For example, the verification engine 195 may extract a projected PVR 110 extracted from the CIS 165 of the media content to be verified, and retrieve an actual PVR 110 of a creation time of the media content. By comparing the projected PVR and the actual PVR, the verification engine 195 may validate whether the media content is predated.

In some examples, the chain laser 170C may include a different color from the clock laser 170A. For example, the verification engine 195 may advantageously detect deepfake videos by analyzing interactions between different wavelengths of the colors and objects in the CIS 165.

In various implementations, a tamper-proof media verification method configured to verify a media having temporally related frames may include verifying a physical signature (e.g., the laser security signature 175) physically projected onto each frames of the media (e.g., the CIS 165). For example, the verification may include comparing a public verifiable random (PVR) value (e.g., the PVR 110, the clock laser 170A) derived from the physical signature and a decentralized ledger (e.g., the decentralized blockchain 190A) associated with the media. For example, the verification may include comparing a depth marker (e.g., the depth laser 170B) with an image depth of a corresponding frame. For example, the verification may include validating a continuity of the media by comparing a first hash (e.g., the chain laser 170C) derived from the physical signature and a second hash of a previous frame.

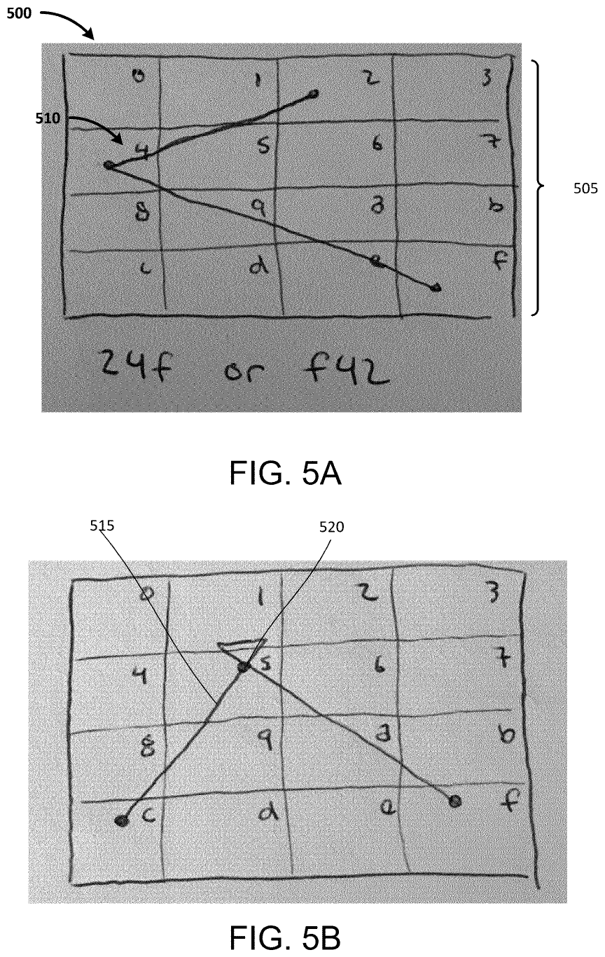

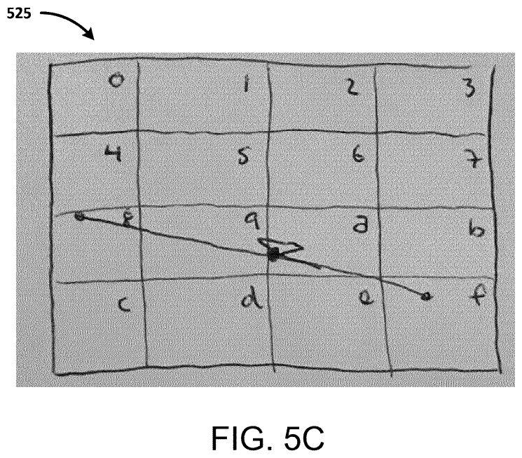

As an illustrative example without limitation, the clock laser 170A may use the PVR 110 to create a light pattern (e.g., in hexadecimal as described with reference to FIGS. 5A-C). For example, the light pattern may be captured in media frames. For example, when there is no new PVR, the clock laser 170A may trace a hash of a previous (e.g., 1, 2, 3, 5) frames ago. The depth laser 170B, for example, may use the hash of a previous frame to create a light pattern on the CIS 165. For example, the chain laser 170C may follow the depth laser 170B's path. For example, the light patterns generated by the clock laser 170A, the depth laser 170B, and the chain laser 170C may be combined into the laser security signature 175 on the CIS 165.

In some examples, the PMVS 100 may solve a technical problem of having a concentrated risk in using a single trusted entity for provenance video verification. For example, some single trusted entity may be motivated to hide facts of compromise. The PMVS 100, in some embodiments, may implement a zero trust solution to media provenance and authenticity. For example, the PMVS 100 may generate a tamper-proof media with a narrow time window (e.g., within a validity time frame of the PVR 110). In some examples, the PMVS 100 may use the PVR 110 for establishing a “not before” times (e.g., video pre-recorded may be prevented from overlaying a yet to know PVR into the media frames). For example, the PMVS 100 may store the verification records 150 in the decentralized blockchain 190A to establish a “not after” time (e.g., fake video post-recorded may be prevented from registering into the decentralized blockchain 190A). In some embodiments, the CIS 165 may prevent replay of pre-recorded content through an association with physical world properties of the CIS 165.

FIG. 2 is a block diagram depicting an exemplary media provenance real-time verifier (MPRV). The MPRV 120 includes a processor 205. The processor 205 may, for example, include one or more processing units. The processor 205 is operably coupled to a communication module 210. The communication module 210 may, for example, include wired communication. The communication module 210 may, for example, include wireless communication. In the depicted example, the communication module 210 is operably coupled to a communication network 215 (e.g., the Internet), the PVRGN 105, the laser tracing device 135, the camera 140, and the decentralized blockchain 190A.

The processor 205 is operably coupled to a memory module 220. The memory module 220 may, for example, include one or more memory modules (e.g., random-access memory (RAM)). The processor 205 includes a storage module 225. The storage module 225 may, for example, include one or more storage modules (e.g., non-volatile memory). In the depicted example, the storage module 225 includes the certification engine 130. For example, the certification engine 130 may generate a session certificate when a new recording session request is received from the camera 140. For example, a recording session may be a network session between the camera 140 and the PMVS 100. For example, the session certificate may include a Digital Object Identifier (DOI) of a verifiable media generated from the recording session.

The storage module 225 also includes a startdate generation engine (SGE 230). For example, the SGE 230 may generate StarDate based on an accumulation of PVR received from the PVRGN 105. For example, timestamps may be generated based on the StarDate 125.

The storage module 225 includes, in this example, a verification records generation engine (VRGE 235), a laser path extraction engine (LPEE 240), and a PVR extraction engine (PEE 245). For example, after returning the session certificate and/or a session key to the camera 140, the PMVS 100 may stream the StarDate 125 to the camera 140 by the SGE 230. For every n media frames, the PMVS 100 may receive, for example, a verification record. For example, the number n may be preconfigured (e.g., user-selected). For example, the verification record may include the StarDate 125 for the frame and a (e.g., MD5) hash of the frame's contents (e.g., a jpeg hash, a bitmap hash). For example, the VRGE 235 may process the verification record received. For example, the verification record may be signed by the session key. In some implementations, the VRGE 235 may store the verification records 150 in the decentralized blockchain 190A. In some examples, the VRGE 235 may store the verification records 150 in other databases.

The LPEE 240, for example, may process the laser security signature 175 captured in each frame. For example, a user may upload a media (e.g., via a link, via a media file). For example, the LPEE 240 may process media frames in the media to extract the laser security signature 175 in each CIS 165 of the media. For example, the LPEE 240 may extract the clock laser 170A, the depth laser 170B, and the chain laser 170C from the media frame.

For example, the PEE 245 may extract the PVR from the clock laser 170A captured in the media frame. In various examples, the MPRV 120 may verify a media using a double frame scoring analysis, a single frame scoring analysis, a depth analysis, and a continuity analysis. In this example, the storage module 225 includes a hash finding engine (HFE 250) and a time validation engine (TVE 255). For example, the HFE 250 may generate a hash (e.g., a jpeg hash) of the media frame and match it in the decentralized blockchain 190A. if there is a match, it is determined that

If you have a jpeg hash match on the blockchain, the media frame (e.g., a photo) was not tampered.

From the laser security signature 175, the LPEE 240 may deduce the laser pattern (e.g., the laser security signature 175) and the PEE 245 may determine the PVR from the laser security signature 175. In some implementations, the TVE 255 may send a request to the decentralized blockchain 190A to be settled. For example, the TVE 255 may receive a settled signal if the image is real and untampered. For example, the PVR matches one of the hashes in a block settled within 60 seconds of PTN consensus.

The processor 205 is further operably coupled to a data store 260. The data store 260 includes the verification records 150, the StarDate 125, and the PVR 110. In this example, the data store 260 includes a calibrated parameters 265. For example, the calibrated parameters 265 includes a predetermined offset between the clock laser 170A and the depth laser 170B. In some examples, the calibrated parameters 265 includes a maximum range provided by the laser emitter module 160.

In some implementations, a distance information of the media frame may be encoded with the PVR 110. For example, based on the calibrated parameters 265, the MPRV 120 may determine a distance and depth of an image captured by applying parallax to the clock laser 170A and the depth laser 170B with, for example, the predetermined offset in the calibrated parameters 265. For example, if the depth everywhere in the frame is too similar/the same, the MPRV 120 may mark the frame as suspicious. If the depth is varied, for example, the MPRV 120 may determine that this frame is not pre-recorded.

In some implementations, for a media stream (e.g., a video), there are more than one media frames to be validated. In some implementations, a single frame may not be marked as “suspicious” if only one frame of the video has a depth variance below a predetermined threshold. For example, if a predetermined number of the media frames have no depth, the MPRV 120 may mark the media stream as will either be marked as either “suspicious”or “fake/rerecorded”.

FIG. 3A and FIG. 3B depict an exemplary laser security signature projected onto a scene. For example, the laser instruction generation engine 155 may project the laser security signature 175 on a projection 300. As shown in FIG. 3A, the projection 300 includes the clock laser 170A and the depth laser 170B. In this example, a clock laser 170A may, upon receiving a new PVR, trace the new PVR into the scene. When no new PVR is received, for example, the clock laser 170A may take a previous frame's hash and trace the previous frame's hash into the scene. In some embodiments, the clock laser 170A and the depth laser 170B may do a depth calibration by tracing a path through every value box (e.g., as described with reference to FIGS. 5A-C) in the frame in some random order determined by PVR.

In some implementations, the clock laser 170A and the depth laser 170B may be placed in close proximity. For example, the clock laser 170A and the depth laser 170B may be configured to trace an exact path with fixed offset. For example, the depth laser 170B may be offset 305 from the clock laser 170A.

In some implementations, the clock laser 170A may aim slightly to the right of the center of each value box and the depth laser 170B may aim slightly to the left of the center of each value box for every odd frame, and vice versa on even frames. For example, the variation may eliminate a need to insert blank frames to find the laser security signature 175 during validation.

For example, the laser security signature 175 may be emitted by the laser tracing device 135. The laser tracing device 135 may be controlled remotely, for example. In some examples, a first frame of a recording session may include the PVR being traced by the clock laser 170A. For example, the PVR may be traced by the depth laser 170B an offset path.

As shown in FIG. 3B, a projection 315 of a second frame includes the clock laser 170A, the depth laser 170B, and the chain laser 170C. In some implementations, each of the lasers may trace through at least 3 points in every frame. In this example, the chain laser 170C traces the path of the clock laser 170A as shown in FIG. 3A. In some implementations, the laser instruction generation engine 155 may generate instructions for the laser emitter module 160 to be, for any frame n, n>1 (where 1 is the first frame):
The clock laser 170A traces a new PVR, and if no new PVR, traces frame n−1's hash;
The depth laser 170B follows the clock laser 170A with a predetermined offset 310; and,
The chain laser 170C traces a path of the clock laser 170A from frame n−1.

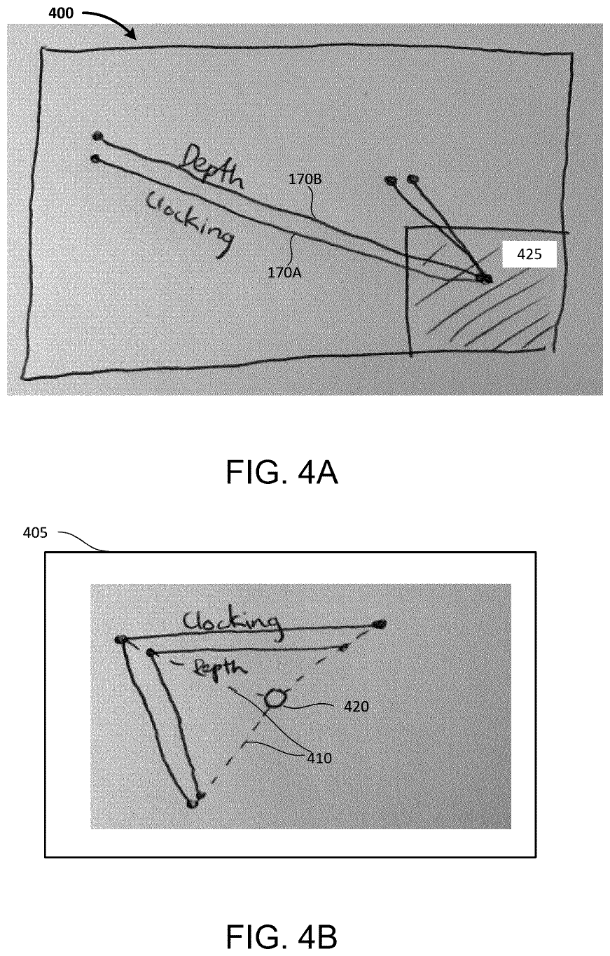

FIG. 4A and FIG. 4B depict exemplary clock laser and depth laser projections configured to represent a depth marker of a captured scene. As shown in FIG. 4A, the clock laser 170A and the depth laser 170B may be configured to cross at a predetermined depth 425 (e.g., a maximum depth supported by the laser tracing device 135, 30 m, 50 m, 100 m) in a scene 400. As shown in FIG. 4B, the depth laser 170B may be configured to be on an axis 410 defined by a center 420 of a frame 405 and the clock laser 170A. For example, the MPRV 120 may apply a parallax analysis to determine a depth based on a predetermined relationship described in FIGS. 4A-B.

FIG. 5A, FIG. 5B, and FIG. 5C depict exemplary value boxes configured to represent various values in a scene. As shown in FIG. 5A, a scene 500 is split into hexadecimal boxes. For example, each hex digit may be represented in a portion of the scene 500 based on the value boxes 505. In this example, a laser trace 510 may represent a value 24f or f24. In some implementations, the scene 500 may be divided into other configurations. For example, the scene 500 may include value boxes in base-64.

In some implementations, as shown in FIG. 5B, in order to identify the middle position(s) of a value represented by a laser trace 515 In the depicted example, the laser trace 515 includes a special gesture 520 (e.g., a loop) at a middle desired position (at the corresponding value box). For example, a value traced by the laser trace 515 may be c5f or f5c. As another illustrative example without limitation, a trace 525 may represent a value of 8af or fa8 as shown in FIG. 5C.

FIG. 6 is a block diagram depicting an exemplary consensus process 600 in selecting a public verifiable random value. In this example, the exemplary consensus process 600 includes multiple telescopic nodes 605. For example, each of the multiple telescopic nodes 605 may include the PVRGN 105.

In some implementations, a size the radio telescope 105B of the multiple telescopic nodes 605 may depend on a required precision of the PTN to be measured. In some examples, the exemplary consensus process 600 may require at least a two meter telescope. In some examples, the exemplary consensus process 600 may require at least a five meter telescope. In some implementations, each of the multiple telescopic nodes 605 may be assigned a key pair. For example, observations made by a telescope may be signed by the assigned key.

The exemplary consensus process 600 includes a consensus protocol 610. For example, the consensus protocol 610 may be similar to the RAFT protocol. In some implementations, the multiple telescopic nodes 605 may come to a consensus about a measured PTN. In some examples, the consensus protocol 610 may include selecting a rotating leader 615. For example, the rotating leader 615 may be selected based on time zone, location, with a general RAFT election, or a combination thereof.

As an illustrative example, all telescopes in the network may sign, with their private key, and send their observations to the rotating leader 615. If the rotating leader 615 received the same observation from a predetermined portion (e.g., 51%, 60%, 75%, 90%) of the multiple telescopic nodes 605, that observation is approved and converted to a PVR 620.

In some implementations, the observations received from the multiple telescopic nodes 605 may be time-limited. For example, the observations may expire within a maximum time (e.g., of 100 ms, 200 ms, more than 300ms). For example, all observations may be validated within the maximum time to advantageously ensure accuracy and prevent tampering with the data.

In some implementations, the multiple telescopic nodes 605 may be configured as a PVR blockchain. For example, each of the nodes 105A may be a node in the PVR blockchain. For example, each node of the PVR blockchain may receive a request to settle a block. For example, the node may ping to the rotating leader 615. For example, the request may be put in a queue with all of the other nodes that are ready to settle blocks.

When the exemplary consensus process 600 acquires a new PTN value and derives the PVR 620. The PVR 620 may, for example, be used to select from the rotating leader 615's queued nodes to settle the block. Various embodiments may advantageously ensure a truly random and unbiased selection process, leveraging the inherent unpredictability of the PTN. For example, the PVR block chain may be applicable to use cases requiring a fast block settlement. In some implementations, the settlement speed may be improved by sharding via multiple PVRs per node. For example, the PVR blockchain may be applicable in payment processing using app keys.

FIG. 7 is a flowchart illustrating an exemplary provable video generation method. For example, the PMVS 100 may perform a method 700 as shown to generate a provable real media. In this example, the method 700 begins in step 705 when a session certificate is generated upon receiving a recording session request from a camera to capture a media. For example, the media may include still images. For example, the media may include videos having multiple temporally sequenced frames. For example, the camera 140 may transmit a request to the MPRV 120 to receive a session certificate. For example, the MPRV 120 may generate a session object 145 associated with the session certificate.

In step 710, a first digital signature is generated as a function of a time-specific PVR value. For example, the laser instruction generation engine 155 may generate the clock laser 170A based on the PVR 110. For example, if no new PVR is received, the laser instruction generation engine 155 may generate the clock laser 170A based on a hash of a previous frame.

Next, a second digital signature related to a physical measurement of a scene captured by a media frame is generated in step 715. For example, the laser instruction generation engine 155 may generate the depth laser 170B based on a predetermined offset from the 170|A//. In some examples, the predetermined offset may be related to deriving an image depth property of the CIS 165.

In a decision point 720, it is determined whether this is a first media frame. If this is a first media frame, a third digital signature is set to be zero. For example, the laser instruction generation engine 155 may deactivate the chain laser 170C if this is the first frame in the recording session. If this is not the first media frame, the third digital signature is generated based on a previous frame's first digital signature. For example, the laser instruction generation engine 155 may generate the chain laser 170C based on a hash of the previous frame. For example, the laser instruction generation engine 155 may generate the chain laser 170C to be following the clock laser 170A of a previous frame.

After the step 725 or the step 730, the first, the second, and the third digital signature are transformed into a laser security signature to be traced and physically captured by the camera in step 735. For example, the laser emitter module 160 may generate the laser security signature 175 to be traced in the CIS 165 and captured by the camera 140.

In step 740, a verification record of the media frame is generated. For example, the verification records 150 may include the laser security signature 175 and a hash of the media frame. Next, in step 745, the verification record is uploaded to a decentralized ledger after being signed by the session certificate.

In a decision point 750, it is determined whether more media frames are to be captured. If no more media frames are to be captured, the method 700 ends. If more media frames are to be captured, the step 710 is repeated. Various embodiments may advantageously automatically generate a tamper-proof media comprising a sequence of media frames by associating a security signature stored in a decentralized ledger and comprising a public verifiable random value, a physical value related to the media frame, and a continuity value.

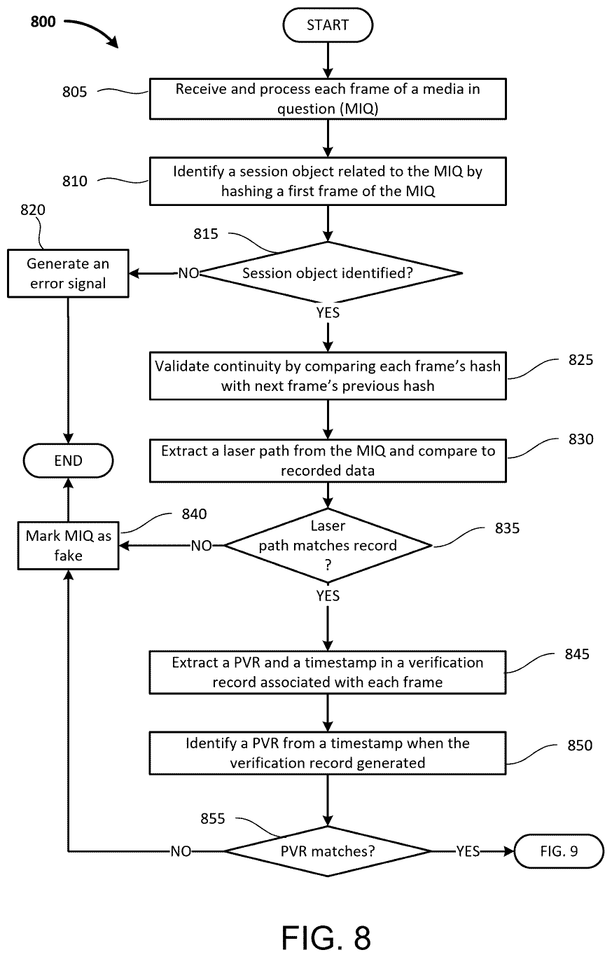

FIG. 8 is a flowchart illustrating an exemplary provenance media verification record validation method 800. For example, the method 800 may be performed by the MPRV 120 to verify a validity of verification records (e.g., the verification records 150) associated with a media in question (MIQ) is valid. In this example, the method 800 begins in step 805 when each frame of a media in question (MIQ) (e.g., a photo, a video) is received and processed. For example, the MIQ may include a temporal sequence of media frames. For example, the verification engine 195 may process the MIQ frame by frame.

Next, a session object related to the MIQ is identified by hashing a first frame of the MIQ in step 810. For example, a first frame of the video may be hashed to match a value in the decentralized blockchain 190A.

In a decision point 815, it is determined whether any session object is identified based on the hash value of the first frame. For example, the MPRV 120 may use a one-way hashing algorithm to hash every frame in a recording session. For example, if a hash generated from the first frame matches a hash on the decentralized blockchain 190A, the MPRV 120 may determine that this first frame is the same frame as recorded in the decentralized blockchain 190A. For example, this may mean that the frame hasn't been edited since the hash was published to the decentralized blockchain 190A. For example, the MPRV 120 may identify, based on the matching, a verification record that was signed by a session certificate of the recording session associated with the MIQ. The session certificate may include a corresponding session object associated with the MIQ.

If no session object is identified, an error signal is generated in step 820, and the method 800 ends. If a session object is identified, in step 825, a continuity of the verification frame is validated by comparing each frame's hash with the next frame's previous hash. For example, the session object may include a directory of every record signed with the session certificate. For example, the verification records 150 may include a PVR, a hash, and/or other value used to determine each laser's path in the frame. For example, a continuity of the verification records 150 may be validated by comparing each frame's hash with the next frame's previous hash in each of the verification records 150.

In some implementations, some records may never be published to the decentralized blockchain 190A due to some errors (e.g., network errors, device errors). For example, the MPRV 120 may be configured to identify these possibilities of discontinuity. In some examples, the MPRV 120 may disregard the continuity issues but made note of them in a final grading report.

In step 830, a laser path is extracted from the MIQ and is compared to recorded data. For example, a laser path may be extracted from the MIQ by the LPEE 240. For example, the LPEE 240 may compare the extracted laser path with a recorded laser path stated in the verification records 150.

In a decision point 835, it is determined whether the laser path matches the verification record. For example, the verification record 150 may include a laser emission instructions of the media frame from the laser instruction generation engine 155. If they do not match, in step 840, the MIQ is marked as fake, and the method 800 ends. If they match, in step 845, a PVR and a timestamp in a verification record associated with each frame is extracted. In step 850, a PVR at the time when the verification record is generated based on the timestamp. For example, the MPRV 120 may identify a PVR settled in the decentralized blockchain 190A in previous 20 seconds before the verification record is generated.

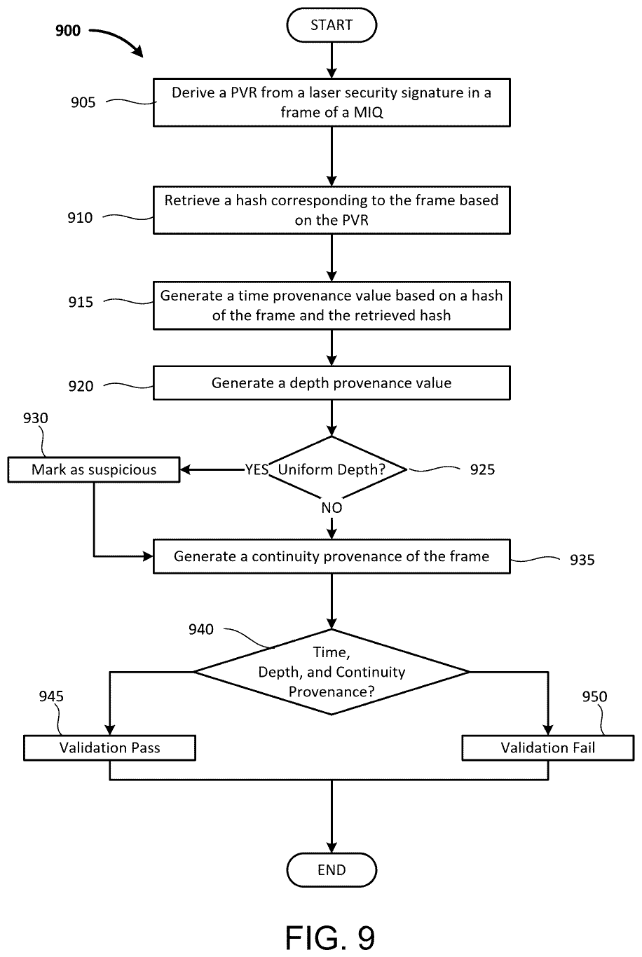

In a decision point 855, it is determined whether there is a match between the PVR in the verification record and the PVR in the decentralized blockchain. If there is a match, the method 800 proceeds to a signature verification method (e.g., FIG. 9). For example, a match may indicate that the PVR in the verification records is a genuine PVR. If there is no match, the step 840 is performed.

FIG. 9 is a flowchart illustrating an exemplary provable video real-time verification method. In this example, a method 900 may be performed by the MPRV 120. For example, the MPRV 120 may perform the method 900 after processing a media in question (MIQ) frame by frame. The method 900 begins when a PVR is derived from a laser security signature in a frame of a MIQ in step 905. For example, each frame in the MIQ may include the laser security signature 175. The PEE 245 may derive a PVR embedded in the laser security signature 175. In step 910, a hash corresponding to the frame is retrieved based on the PVR. For example, the PVR derived by the PEE 245 may point to a rough time range when a block containing the (jpeg) hash corresponding to the media frame was settled.

In step 915, a time provenance value is generated based on a hash of the frame and the retrieved hash. The verification engine 195, for example, may check to see if the hash of the frame matches any of the hash within the time range. If the frame matches any of the recorded hash on the decentralized blockchain 190A, for example, the verification engine 195 may determine that the frame wasn't taken after that point in time.

Next, a depth provenance value is generated in step 920. For example, the LPEE 240 may extract a path of the depth laser 170B. In some embodiments, the verification engine 195 may examine varying distances between the clock laser 170A and the depth laser 170B.

In a decision point 925, it is determined whether depths recorded within the frame are consistent throughout. For example, uniform depth may suggest a frame being recorded screen-on-screen. For example, recording screen-on-screen may indicate an attempt to pass a previously captured media as a newly captured media. In this example, in step 930, if a frame is determined to have a uniform depth, the frame is marked as “suspicious.” In some embodiments, the verification engine 195 may include one or more transformer models to identify whether or not there should be depth in the image. For videos, for example, the verification engine 195 may analyze multiple frames. For example, if multiple frames exhibit no depth differentiation, the video may be determined to be fake.

In step 935, a continuity provenance value of the frame is generated. For example, the continuity provenance value may be generated based on a result at the step 825. In a decision point 940, it is determined whether the frame has time, depth, and continuity provenance. If the frame has time, depth, and continuity provenance, validation is passed in step 945. If the frame has time, depth, and continuity provenance, validation is failed in step 950. The method 900 ends after the step 945 or step 950. Various embodiments may advantageously validate a media frame to be both authentic and untampered with a multi-layered validation process.

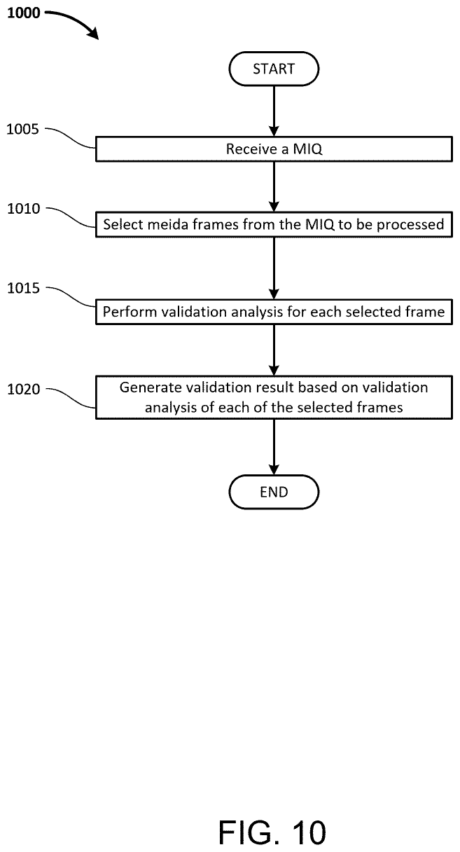

FIG. 10 is a flowchart illustrating an exemplary runtime verification method. For example, the verification engine 195 may perform a method 1000 as shown to process each frame of a MIQ as described with reference to FIGS. 8-9. In this example, the method 1000 begins when a MIQ is received in step 1005. For example, the MIQ may be a video or an image uploaded from the media storage 190B. In step 1010, media frames are selected from the MIQ to be processed. For example, the verification engine 195 may select the media frame from the MIQ based on a predetermined parameter. For example, if the verification engine 195 may select every frame in the MIQ to be analyzed. For example, if the verification engine 195 may select one frame from every five frames to be analyzed. For example, if the predetermined parameter may include other frequency of frames to be selected based on speed and/or accuracy requirements.

In step 1015, a validation analysis is performed for each selected frame. For example, the verification engine 195 may perform the method 800 and/or the method 900 to each of the selected frames. In step 1020, a result is generated based on validation analysis of each of the selected frames, and the method 1000 ends.

Although various embodiments have been described with reference to the figures, other embodiments are possible. In some implementations, the laser tracing device 135 may generate also mapping seed for hashing color of emitted laser. In some implementations, the laser tracing device 135 may also project a seed for hashing of the StarDate 125. For example, the hashing seed for the StarDate 125 may obfuscate time or location. For example, the seeds may be stored in an intermediate certificate.

In some implementations, the verification engine 195 may include an image search engine to provide image similarity searching.

In some implementations, the laser emitter module 160 may include an infrared and/or an ultraviolet laser emitter. For example, the laser emitter module 160. May include matching color coupled devices (CCDs) and alternate color channels. For example, the CIS 165 may include intermarking of location data (e.g., based on GPS signal contents, pseudo-range). For example, the intermarking may include information of authorship.

In some implementations, the hashing engine may include a bitmap hash. For example, the verification engine 195 may identify a similarity and/or variation of an edited photo. For example, the verification engine 195 may be configured to validate a photo if it is over a predetermined similarity threshold. Various embodiments may advantageously allow validation of images with some amount of editing.

In some implementations, the verification engine 195 may be configured to also validate images without the lasers (e.g., after the laser traces are removed from the image). For example, the verification engine 195 may be configured to traceback (e.g., through a public storage, through a private storage, through a decentralized leger) the new image to an original image to confirm whether the new image is real.

Although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a (nominal) batteries, for example. Alternating current (AC) inputs, which may be provided, for example, from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a system may include a data store may include a program of instructions. For example, the system may include a processor operably coupled to the data store such that, when the processor executes the program of instructions, the processor causes operations to be performed to automatically generate a tamper-proof media may include a sequence of media frames by associating a security signature stored in a decentralized ledger may include a public verifiable random value, a physical value, and a continuity value.

For example, the operations may include generate a first digital signature as a function of the public verifiable random value associated with a globally observable event retrieved from a decentralized consensus network. For example, the operations may include generate a second digital signature related to a physical measurement related to a media frame. For example, the operations may include generate a third digital signature as a function of a previous first digital signature of a previous media frame.

For example, the operations may include transform the first digital signature, the second digital signature, and the third digital signature into a laser security signature to be physically captured into the media frame by a media capturing device.

For example, the operations may include, for each media frame, generate a verification record to be stored in a decentralized ledger. For example, the verification record may include a timestamp associated with the public verifiable random value and a hash of the media frame, such that a plurality of tamper-proof verification records in the decentralized ledger may be associated with a media stream of the sequence of media frames, and the media stream may be verifiable in time, physical properties, and continuity.

For example, the system may include one or more of below features:
For example, the verification record may be signed by a session certificate associated with the media stream.
For example, the decentralized consensus network may include a network of telescope nodes configured to measure pulsars time noise. For example, each telescope node may include a computing device and a telescope.
For example, the decentralized consensus network may be operated as a blockchain. For example, the decentralized ledger may be settled based on a consensus of the public verifiable random value generated as a function of a truly random event of physical phenomena by selected telescope nodes of the decentralized consensus network.
For example, the system may include a laser emitting device configured to emit the laser security signature onto the media frame to be captured by the media capturing device.
For example, the media frame may be divided into a fixed number of frame portions. For example, each of the frame portion represents a numerical value, and the laser emitting device may include a clock laser configured to trace the first signature onto the media frame, a chain laser configured to trace the third digital signature onto the media frame, and a depth laser configured to trace the second digital signature by following a calibrated offset path of the clock laser, such that the physical measurement may include a depth marker of the media frame may be captured.
For example, the operations may include verifying a media frame of the media stream. For example, verifying the media may include retrieve the plurality of tamper-proof verification records associated with the media stream from the decentralized ledger, select a verification record corresponding to the media frame, extract the laser security signature from the media frame, generate a time provenance value by matching a hash value of the media frame to hash values retrieved from the verification records in the decentralized ledger settled within a range of time based on the first digital signature encoded in the laser security signature, generate a depth provenance value by generating a depth profile of the media frame as a function of the first digital signature and the second digital signature, and when the time provenance value and the depth provenance value are passed, generate a continuity provenance value of the media frame by comparing the third digital signature and a first digital signature derived from a temporally previous media frame, such that the media frame may be proved to be real when it has time provenance, image depth provenance, and continuity provenance.

In an illustrative aspect, a computer-implemented method performed by at least one processor to automatically generate a tamper-proof media may include a sequence of media frames by associating a security signature stored in a distributed storage system. For example, the method may include retrieve a plurality of tamper-proof verification records associated with the sequence of media frames from a decentralized ledger.

For example, the method may include select a verification record corresponding to a media frame of the tamper-proof media. For example, the verification record may include a timestamp related to a public verifiable random value, and a hash value of the media frame. For example, the method may include extract, from the media frame, a laser security signature.

For example, the laser security signature may include a first signature may include a public verifiable random value, a second signature may include a depth marker of the frame, and a third signature may include a hash of the first signature of a temporally previous media frame.

For example, the method may include generate a time provenance value by matching a hash value of the media frame to hash values in the decentralized ledger settled within a range of time based on the first signature. For example, the method may include generate a depth provenance value by generating a depth profile of the media frame as a function of the first signature and the second signature. For example, the method may include, when the time provenance value and the depth provenance value are passed, generate a continuity provenance value of the media frame by comparing the third signature and a first signature derived from the temporally previous media frame, such that the media frame may be proved to be real when it has time provenance, image depth provenance, and continuity provenance.

For example, the method may include one or more of below features:
For example, the laser security signature may be projected onto a scene captured by a camera by a laser emitting device.
For example, the scene may be divided into a fixed number of frame portions. For example, each of the frame portions represents a numerical value. For example, the laser emitting device may include a clock laser configured to trace the first signature onto the media frame, a chain laser configured to trace the third signature onto the media frame, a depth laser configured to follow a calibrated offset path of the clock laser such that the depth marker encodes an image depth information of the scene.
For example, the public verifiable random value may be associated with a globally observable event generated from a decentralized consensus network.
For example, the decentralized consensus network may include a network of telescope nodes configured to measure pulsars time noise. For example, each telescope node may include a computing device and a telescope.
For example, the decentralized consensus network may be operated as a blockchain. For example, the decentralized ledger may be settled based on the public verifiable random value generated as a function of a truly random event of physical phenomena by selected telescope nodes of the decentralized consensus network.
The computer-implemented method may include, in response to a recording request, generate a session certificate to a remote device. The method may include receive the plurality of tamper-proof verification records associated with and signed by the session certificate. The method may include store the plurality of tamper-proof verification records in the decentralized ledger.

In an illustrative aspect, a computer program product may include a program of instructions tangibly embodied on a computer readable medium wherein when the instructions are executed on a processor, the processor causes operations to be performed to automatically verify a provenance of a media file of temporally related frames. For example, the operations may include retrieve a plurality of tamper-proof verification records associated with the media file from a decentralized ledger. For example, the operations may include select a verification record corresponding to a media frame of the media file. For example, the verification record may include a timestamp related to a public verifiable random value, and a hash value of the media frame.

For example, the operations may include extract, from the media frame. a laser security signature. For example, the laser security signature may include a first signature. For example, the first signature may include a public verifiable random value. For example, the laser security signature may include a second signature may include a depth marker of the media frame. For example, the laser security signature may include a third signature may include a hash of the first signature of a temporally previous media frame.

For example, the operations may include generate a time provenance value by matching a hash value of the media frame to hash values in the decentralized ledger settled within a range of time based on the first signature. For example, the operations may include generate a depth provenance value by generating a depth profile of the media frame as a function of the first signature and the second signature.

For example, the operations may include, when the time provenance value and the depth provenance value are passed, generate a continuity provenance value of the media frame by comparing the third signature and a first signature derived from the temporally previous media frame, such that the media frame may be proved to be real when it has time provenance, image depth provenance, and continuity provenance.

For example, the computer program product may include one or more of below features:
For example, the laser security signature may be projected onto a scene captured by a camera by a laser emitting device.
For example, the scene may be divided into a fixed number of frame portions. For example, each of the frame portions represents a numerical value, and the laser emitting device may include a clock laser configured to trace the first signature onto the media frame, a chain laser configured to trace the third signature onto the media frame, a depth laser configured to follow a calibrated offset path of the clock laser, such that the depth marker encodes an image depth information of the scene.
For example, the public verifiable random value may be associated with a globally observable event generated from a decentralized consensus network.
For example, the decentralized consensus network may include a network of telescope nodes configured to measure pulsars time noise. For example, each telescope node may include a computing device and a telescope.
For example, the decentralized consensus network may be operated as a blockchain. For example, the decentralized ledger may be settled based on the public verifiable random value generated as a function of a truly random event of physical phenomena by selected telescope nodes of the decentralized consensus network.

In some implementations, the system may include some or all of the features of the computer implemented method. In some implementations, the system may include some or all of the features of the computer program product. In some implementations, the computer implemented method may include some or all of the features of the system. In some implementations, the computer implemented method may include some or all of the features of the computer program product. In some implementations, the computer program product may include some or all of the features of the system. In some implementations, the computer program product may include some or all of the features of the computer implemented method.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. (canceled)

2. The system of claim 6, wherein the verification record is signed by a session certificate associated with the media stream.

3. The system of claim 6, wherein the decentralized consensus network comprises a network of telescope nodes configured to measure pulsars time noise, wherein each telescope node comprises a computing device and a telescope.

4. The system of claim 3, wherein the decentralized consensus network is operated as a blockchain, wherein the decentralized ledger is settled based on a consensus of the public verifiable random value generated as a function of a truly random event of physical phenomena by selected telescope nodes of the decentralized consensus network.

5. (canceled)

6. A system comprising:
a data store comprising a program of instructions; and,
a processor operably coupled to the data store such that, when the processor executes the program of instructions, the processor causes operations to be performed to automatically generate a tamper-proof media comprising a sequence of media frames by associating a security signature stored in a decentralized ledger comprising a public verifiable random value, a physical value, and a continuity value, the operations comprising:
generate a first digital signature as a function of the public verifiable random value associated with a globally observable event retrieved from a decentralized consensus network;
generate a second digital signature related to a physical measurement related to a media frame;
generate a third digital signature as a function of a previous first digital signature of a previous media frame;
transform the first digital signature, the second digital signature, and the third digital signature into a laser security signature to be physically captured into the media frame by a media capturing device; and,
for each media frame, generate a verification record to be stored in a decentralized ledger wherein the verification record comprises a timestamp associated with the public verifiable random value and a hash of the media frame, such that a plurality of tamper-proof verification records in the decentralized ledger is associated with a media stream of the sequence of media frames, and the media stream is verifiable in time, physical properties, and continuity, wherein the system further comprises a laser emitting device configured to emit the laser security signature onto the media frame to be captured by the media capturing device, and the media frame is divided into a fixed number of frame portions, wherein each of the frame portion represents a numerical value, and the laser emitting device comprises:
a clock laser configured to trace the first signature onto the media frame;
a chain laser configured to trace the third digital signature onto the media frame; and,
a depth laser configured to trace the second digital signature by following a calibrated offset path of the clock laser, such that the physical measurement comprising a depth marker of the media frame is captured.

7. The system of claim 4, wherein the operations further comprise verifying a media frame of the media stream comprising:
retrieve the plurality of tamper-proof verification records associated with the media stream from the decentralized ledger;
select a verification record corresponding to the media frame;
extract the laser security signature from the media frame;
generate a time provenance value by matching a hash value of the media frame to hash values retrieved from the verification records in the decentralized ledger settled within a range of time based on the first digital signature encoded in the laser security signature;
generate a depth provenance value by generating a depth profile of the media frame as a function of the first digital signature and the second digital signature; and,
when the time provenance value and the depth provenance value are passed, generate a continuity provenance value of the media frame by comparing the third digital signature and a first digital signature derived from a temporally previous media frame, such that the media frame is proved to be real when it has time provenance, image depth provenance, and continuity provenance.

8. (canceled)

9. (canceled)

10. A computer-implemented method performed by at least one processor to automatically generate a tamper-proof media comprising a sequence of media frames by associating a security signature stored in a distributed storage system, the method comprising:
retrieve a plurality of tamper-proof verification records associated with the sequence of media frames from a decentralized ledger;
select a verification record corresponding to a media frame of the tamper-proof media, wherein the verification record comprises a timestamp related to a public verifiable random value, and a hash value of the media frame;
extract, from the media frame, a laser security signature comprising:
a first signature comprises a public verifiable random value;
a second signature comprises a depth marker of the frame; and,
a third signature comprises a hash of the first signature of a temporally previous media frame;
generate a time provenance value by matching a hash value of the media frame to hash values in the decentralized ledger settled within a range of time based on the first signature;
generate a depth provenance value by generating a depth profile of the media frame as a function of the first signature and the second signature; and,
when the time provenance value and the depth provenance value are passed, generate a continuity provenance value of the media frame by comparing the third signature and a first signature derived from the temporally previous media frame, such that the media frame is proved to be real when it has time provenance, image depth provenance, and continuity provenance, wherein:
the laser security signature is projected onto a scene captured by a camera by a laser emitting device; and,
the scene is divided into a fixed number of frame portions, wherein each of the frame portions represents a numerical value, and the laser emitting device comprises:
a clock laser configured to trace the first signature onto the media frame;
a chain laser configured to trace the third signature onto the media frame; and,
a depth laser configured to follow a calibrated offset path of the clock laser such that the depth marker encodes an image depth information of the scene.

11. The computer-implemented method of claim 10, wherein the public verifiable random value is associated with a globally observable event generated from a decentralized consensus network.

12. The computer-implemented method of claim 11, wherein the decentralized consensus network comprises a network of telescope nodes configured to measure pulsars time noise, wherein each telescope node comprises a computing device and a telescope.

13. The computer-implemented method of claim 11, wherein the decentralized consensus network is operated as a blockchain, wherein the decentralized ledger is settled based on the public verifiable random value generated as a function of a truly random event of physical phenomena by selected telescope nodes of the decentralized consensus network.

14. The computer-implemented method of claim 10, further comprises:
in response to a recording request, generate a session certificate to a remote device;
receive the plurality of tamper-proof verification records associated with and signed by the session certificate; and,
store the plurality of tamper-proof verification records in the decentralized ledger.

15. (canceled)

16. (canceled)

17. A computer program product comprising:
a program of instructions tangibly embodied on a computer readable medium wherein when the instructions are executed on a processor, the processor causes operations to be performed to automatically verify a provenance of a media file of temporally related frames, the operations comprising:
retrieve a plurality of tamper-proof verification records associated with the media file from a decentralized ledger;
select a verification record corresponding to a media frame of the media file, wherein the verification record comprises a timestamp related to a public verifiable random value, and a hash value of the media frame; and,
extract, from the media frame, a laser security signature comprising:
a first signature comprises a public verifiable random value;
a second signature comprises a depth marker of the media frame; and,
a third signature comprises a hash of the first signature of a temporally previous media frame;
generate a time provenance value by matching a hash value of the media frame to hash values in the decentralized ledger settled within a range of time based on the first signature;
generate a depth provenance value by generating a depth profile of the media frame as a function of the first signature and the second signature; and,
when the time provenance value and the depth provenance value are passed, generate a continuity provenance value of the media frame by comparing the third signature and a first signature derived from the temporally previous media frame (825), such that the media frame is proved to be real when it has time provenance, image depth provenance, and continuity provenance, wherein:
the laser security signature is projected onto a scene captured by a camera by a laser emitting device; and,
the scene is divided into a fixed number of frame portions, wherein each of the frame portions represents a numerical value, and the laser emitting device comprises:
a clock laser configured to trace the first signature onto the media frame;
a chain laser configured to trace the third signature onto the media frame; and,
a depth laser configured to follow a calibrated offset path of the clock laser, such that the depth marker encodes an image depth information of the scene.

18. The computer program product of claim 17, wherein the public verifiable random value is associated with a globally observable event generated from a decentralized consensus network.

19. The computer program product of claim 18, wherein the decentralized consensus network comprises a network of telescope nodes configured to measure pulsars time noise, wherein each telescope node comprises a computing device and a telescope.

20. The computer program product of claim 18, wherein the decentralized consensus network is operated as a blockchain, wherein the decentralized ledger is settled based on the public verifiable random value generated as a function of a truly random event of physical phenomena by selected telescope nodes of the decentralized consensus network.
